(19) United States
(12) Patent Application Publication
(10) Pub. No.: US 2017/0327671 A1
(43) Pub. Date: Nov. 16, 2017

(54) TIRE RUBBER COMPOSITION MANUFACTURING METHOD AND TIRE RUBBER COMPOSITION

(71) Applicant: SUMITOMO RUBBER INDUSTRIES, LTD., Kobe-shi (JP)

(72) Inventor: Yuka YOKOYAMA, Kobe-shi (JP)

(73) Assignee: SUMITOMO RUBBER INDUSTRIES, LTD., Kobe-shi (JP)

(21) Appl. No.: 15/593,688

(22) Filed: May 12, 2017

(30) Foreign Application Priority Data
May 16, 2016 (JP) 2016-097966

(51) Int. Cl. C08L 9/06

(52) U.S. Cl. CPC C08L 9/06

(57) ABSTRACT

A method for manufacturing a tire rubber composition includes kneading a rubber component, a silane coupling agent and silica such that a content of the silica exceeds 50 parts by mass with respect to 100 parts by mass of the rubber component, adding a vulcanization accelerator to a kneading mixture including the rubber component, the silane coupling agent and the silica, kneading the vulcanization accelerator and the kneading mixture including the rubber component, the silane coupling agent and the silica, adding a vulcanization agent to a resulting mixture including the rubber component, the silane coupling agent, the silica and the vulcanization accelerator, and kneading the vulcanization agent and the resulting mixture including the rubber component, the silane coupling agent, the silica and the vulcanization accelerator such that a kneaded material obtained by the kneading of the vulcanization agent and the resulting mixture has a gel fraction of 30% or less.

### CROSS-REFERENCE TO RELATED APPLICATIONS

The present application is based upon and claims the benefit of priority to Japanese Patent Application No. 2016-097966, filed May 16, 2016, the entire contents of which are incorporated herein by reference.

### BACKGROUND OF THE INVENTION

### Field of the Invention

The present invention relates to a tire rubber composition manufacturing method and a tire rubber composition.

### Description of Background Art

Japanese Translation of PCT International Application Publication No. 2003-523472 describes a tire rubber composition manufacturing method and a tire rubber composition. The entire contents of this publication are incorporated herein by reference.

### SUMMARY OF THE INVENTION

According to one aspect of the present invention, a method for manufacturing a tire rubber composition includes kneading a rubber component, a silane coupling agent and silica such that a content of the silica exceeds 50 parts by mass with respect to 100 parts by mass of the rubber component, adding a vulcanization accelerator to a kneading mixture including the rubber component, the silane coupling agent and the silica, kneading the vulcanization accelerator and the kneading mixture including the rubber component, the silane coupling agent and the silica, adding a vulcanization agent to a resulting mixture including the rubber component, the silane coupling agent, the silica and the vulcanization accelerator, and kneading the vulcanization agent and the resulting mixture including the rubber component, the silane coupling agent, the silica and the vulcanization accelerator such that a kneaded material obtained by the kneading of the vulcanization agent and the resulting mixture has a gel fraction of 30% or less.

According to another aspect of the present invention, a tire rubber composition includes a kneaded material including a rubber component, a silane coupling agent, silica, a vulcanization accelerator, and a vulcanization agent such that the silica has a content exceeding 50 parts by mass with respect to 100 parts by mass of the rubber component and that the kneaded material has a gel fraction of 30% or less.

### DETAILED DESCRIPTION OF THE EMBODIMENTS

The embodiments will now be described.

A tire rubber composition according to an embodiment of the present invention includes a rubber component, a silane coupling agent, silica, a vulcanization accelerator and a vulcanization agent. A content of the silica exceeds 50 parts by mass with respect to 100 parts by mass of the rubber component. The tire rubber composition manufacturing method includes a base kneading process in which the rubber component, the silane coupling agent and the silica are kneaded and thereafter, the vulcanization accelerator is added and the resulting mixture is kneaded; and a finishing kneading process in which the vulcanization agent is added to the kneaded material obtained by the base kneading process and the resulting mixture is kneaded. A gel fraction of the kneaded material obtained by the finishing kneading process is 30% or less.

In an embodiment of the present invention, in the base kneading process, the rubber component, the silane coupling agent and the silica are kneaded, and thereafter, the vulcanization accelerator is added. Thereby, a reaction between the silica and the silane coupling agent is effectively promoted. Further, the gel fraction of the kneaded material after the finishing kneading process is adjusted to a predetermined range or less to inhibit progress of a reaction between the rubber component and the silane coupling agent before vulcanization. In this way, in an embodiment of the present invention, before vulcanization, the reaction between the silica and the silane coupling agent is promoted and the reaction between the rubber component and the silane coupling agent is inhibited. Thereby, dispersibility of the silica can be significantly improved. As a result, even for a rubber composition in which a content of silica exceeds 50 parts by mass and the silica is difficult to be dispersed, the silica can be uniformly dispersed, and low fuel consumption performance, wear resistance and breaking strength can be improved in a well-balanced manner.

A technology for activating a silane coupling agent promotes both a reaction between silica and a silane coupling agent and a reaction between a rubber component and the silane coupling agent. These reactions are antagonistic to each other and thus the reactions are likely non-uniform. In contrast, in an embodiment of the present invention, in a kneading stage before vulcanization, a reaction between a rubber component and a silane coupling agent is suppressed and only a reaction between silica and the silane coupling agent is promoted. During vulcanization after kneading, the reaction between the rubber component and the silane coupling agent is caused to proceed. Thereby, dispersibility of the silica is significantly improved and the silica and the rubber component can uniformly react with each other. As a result, it is thought that excellent low fuel consumption performance, wear resistance and breaking strength can be achieved.

### Base Kneading Process

In the base kneading process, a rubber component, a silane coupling agent and silica are kneaded and thereafter, a vulcanization accelerator is added and the resulting mixture is kneaded.

In the base kneading process, a combined amount of each of the rubber component, the silane coupling agent, the silica and the vulcanization accelerator may be a full amount (total amount used in all processes) or may be a part of the full amount. For a reason that the dispersion of the silica can be further promoted, it is preferable that the rubber component, the silane coupling agent and the silica be combined at their full amounts and kneaded in the base kneading process, and the vulcanization accelerator be partially added and kneaded in the base kneading process and the remaining vulcanization accelerator be added and kneaded in the finishing kneading process.

For the same reasons, before adding the vulcanization accelerator, the rubber component, the silane coupling agent and the silica are respectively combined at preferably 50 mass % or more, more preferably 70 mass % or more, even more preferably 90 mass % or more, and particularly preferably 100 mass % of their full amounts and are kneaded.

In the base kneading process, the rubber component, the silane coupling agent, the silica and the vulcanization accelerator may each be combined at once or may each be dividedly combined. For example, it is also possible that portions of the rubber component, the silane coupling agent and the silica are first kneaded and thereafter, the remaining rubber component, silane coupling agent and silica are combined together with the vulcanization accelerator and the resulting mixture is kneaded.

The kneading in the base kneading process may be performed in one stage or in two or more stages. In an embodiment of the present invention, one-stage kneading means a process in which components are combined and are kneaded and a kneaded material is discharged. Therefore, a case where components are combined at different times before a kneaded material is discharged is also one-stage kneading.

With regard to combine timing of the vulcanization accelerator, for example, when the kneading in the base kneading process is performed in one stage, it is possible that, first, the rubber component, the silane coupling agent and the silica are kneaded and thereafter, the vulcanization accelerator is added and the resulting mixture is kneaded. In this case, it is preferable to combine the vulcanization accelerator and knead the resulting mixture after the kneaded material obtaining by kneading the rubber component, the silane coupling agent and the silica is placed in a kneading machine for a predetermined period of time (preferably 30 seconds-5 minutes) while being adjusted to a predetermined temperature (preferably 130-160° C.).

Further, when the kneading in the base kneading process is performed in two stages, it is possible that, in a first stage of the kneading, the rubber component, the silane coupling agent and the silica are kneaded and the resulting kneaded material is temporarily discharged and thereafter, in a second stage of the kneading, together with the kneaded material obtained in the stage, the vulcanization accelerator is added and the resulting mixture is kneaded. When the kneading in the base kneading process is performed in the two stages and the vulcanization accelerator is added in the second stage, although the number of man-hours is increased, wasteful thermal history can be prevented from being added to the rubber component. Therefore, a hydrolysis reaction of the silane coupling agent, dispersion of the silica, and a polycondensation reaction between the silane coupling agent and the silica can be promoted in a well-balanced manner.

Before the vulcanization accelerator is added, a kneading time for kneading the rubber component, the silane coupling agent and the silica is preferably 30 seconds or more, more preferably 60 seconds or more, and even more preferably 80 seconds or more. When the kneading time is less than 30 seconds, there is a risk that the hydrolysis reaction of the silane coupling agent cannot be sufficiently progressed. An upper limit of the kneading time is not particularly limited, but is preferably 30 minutes or less, and more preferably 5 minutes or less. When the kneading time exceeds 30 minutes, there is a risk that the rubber component may deteriorate and the wear resistance may decrease.

Further, a kneading time after the vulcanization accelerator is added is not particularly limited. However, the kneading time is preferably 30 seconds-30 minutes, and more preferably 80 seconds-5 minutes.

Examples of the rubber component that is combined in the base kneading process include diene-based rubbers such as a natural rubber (NR), an epoxidized natural rubber (ENR), an isoprene rubber (IR), a butadiene rubber (BR) and a styrene butadiene rubber (SBR). These rubbers may each be independently used, or two or more of these rubbers may be used in combination. Among these rubbers, SBR and BR are preferable, and BR is more preferable. Further, from a point of view of wear resistance and low fuel consumption performance, it is preferable to use a high cis BR having a cis content of 70 mass % or more and a weight-average molecular weight of 300,000 or more as BR.

In an embodiment of the present invention, a cis content is a value calculated based on an infrared absorption spectrum analysis, and a weight-average molecular weight is a value obtained by standard polystyrene conversion based on a measured value using a gel permeation chromatograph (GPC) (GPC-8000 series manufactured by Tosoh Corporation; detector: differential refractometer; column: TSKGEL SUPERMULTIPORE HZ-M manufactured by Tosoh Corporation).

From a point of view of low fuel consumption performance, wear resistance and breaking strength, SBR and high cis BR are preferably respectively modified rubbers (modified SBR and modified high cis BR) each having a functional group that reacts with silica. The functional group is not particularly limited. However, examples of the functional group include an alkoxysilyl group, an amino group, a hydroxyl group, a carboxy group, an amide group, an epoxy group, an imino group, a cyano group and the like. These functional groups may each be introduced into either a terminal of a polymer chain or into a main chain, and multiple functional groups may be introduced into a polymer chain. Among these functional groups, for a reason that a strong bond can be formed with silica, the alkoxysilyl group, the amino group, the hydroxyl group and the amide group are preferable, and the alkoxysilyl group and the amino group are more preferable.

When a modified rubber is used, Mooney viscosity rises and the components become difficult to disperse. Therefore, a reaction of the silane coupling agent cannot uniformly proceed, and wear resistance may decrease. However, in a kneading method according to an embodiment of the present invention, the components can be satisfactorily dispersed and thus, a decrease in wear resistance due to the use of a modified rubber can be suppressed.

The silane coupling agent that is combined in the base kneading process is not particularly limited. However, examples of the silane coupling agent include sulfide-based, mercapto-based, vinyl-based, amino-based, glycidoxy-based, nitro-based, and chloro-based silane coupling agents. These silane coupling agents may each be independently used, or two or more of these silane coupling agents may be used in combination. Among these silane coupling agents, the sulfide-based and mercapto-based silane coupling agents are preferable. As the sulfide-based silane coupling agents, bis(3-triethoxysilylpropyl) disulfide, bis(3-triethoxysilylpropyl) tetrasulfide and the like can be used. As the mercapto-based silane coupling agents, “NXT silane” manufactured by Momentive Corporation and “Si363” manufactured by Evonik Corporation can be used.

The silica that is combined in the base kneading process is not particularly limited. However, silica having a BET specific surface area of 150 m²/g or more is preferably used. The above-described silica has characteristics such as having an excellent reinforcing property and being excellent in improving wear resistance. However, the above-described silica has a low dispersibility and thus, due to poor dispersion, wear resistance may decrease. In contrast, in a kneading method according to an embodiment of the present invention, even the above-described silica can be satisfactorily dispersed and thus, the effect of improving wear resistance due to the silica can be sufficiently achieved.

From a point of view of wear resistance, the BET specific surface area of the silica is preferably 155 m²/g or more, and more preferably 160 m²/g or more. An upper limit of the BET specific surface area is not particularly limited. However, from a point of view of operability and processability, the BET specific surface area is preferably 400 m²/g or less, and more preferably 300 m²/g or less.

In an embodiment of the present invention, the BET specific surface area is a value measured according to ASTM D3037-81.

From a point of view of an effect of promoting a reaction of the silane coupling agent, the silica has a pH of preferably 4.0 or more and 9.5 or less, and more preferably 5.5 or more and 7.0 or less.

In an embodiment of the present invention, the pH of the silica is a value measure according to JIS K1150.

The vulcanization accelerator that is combined in the base kneading process is not particularly limited. However, examples of the vulcanization accelerator include guanidines, sulfenamides, thiazoles, thiurams, dithiocarbamates, thioureas, xanthogenates, and the like. These vulcanization accelerators may each be independently used, or two or more of these vulcanization accelerators may be used in combination. Among these, for a reason that the effect according to an embodiment of the present invention can be satisfactorily obtained, the guanidines are preferable. Due to a function of the guanidines as soft bases, the polycondensation reaction between the silane coupling agent and the silica is selectively promoted, and the silica is satisfactorily dispersed, and thus, the effect of improving low fuel consumption performance, wear resistance and breaking strength can be improved.

Examples of the guanidines include 1,3-diphenylguanidine, 1,3-di-o-tolylguanidine, 1-o-tolyl biguanide, di-o-tolylguanidine salt of di-catecholborate, 1,3-di-o-cumenylguanidine, 1,3-di-o-biphenylguanidine, 1,3-di-o-cumenyl-2-propionylguanidine, and the like. These guanidines may each be independently used, or two or more of these guanidines may be used in combination. Among these guanidines, 1,3-diphenylguanidine, 1,3-di-o-tolylguanidine, and 1-o-tolylbiguanide are preferable, and 1,3-diphenylguanidine is more preferable.

In the base kneading process, the combined amount of the vulcanization accelerator, with respect to 100 parts by mass of the combined amount of the silica, is preferably 0.1-20 parts by mass, more preferably 0.5-5 parts by mass, and even more preferably 1-3 parts by mass. When the combined amount of the vulcanization accelerator is less than 0.1 parts by mass, there is a risk that the effect of promoting the polycondensation reaction between the silane coupling agent and the silica is not sufficiently obtained, and when the combined amount of the vulcanization accelerator exceeds 20 parts by mass, that is a risk that it may become difficult to control a vulcanization process that is performed after the finishing kneading process and wear resistance may decrease.

In the kneaded material obtained by the base kneading process, that is, the kneaded material to which the vulcanization agent is to be added in the finishing kneading process, a non-reaction rate of the silane coupling agent is preferably less than 20%. When the non-reaction rate of the silane coupling agent is in the above range, the reaction of the silane coupling agent is sufficiently progressed and thus satisfactory low fuel consumption performance, wear resistance and breaking strength can be obtained.

In an embodiment of the present invention, the non-reaction rate of the silane coupling agent is a ratio of a portion of the silane coupling agent combined in the base kneading process that is thought to have not bonded to silica, and is a value measured using a method of examples to be described later.

In the base kneading process, it is also possible that, in addition to the above-described rubber component, silane coupling agent, silica and vulcanization accelerator, other components are added and the resulting mixture is kneaded. The other components are not particularly limited as long as the components are other than the vulcanization agent to be added in the finishing kneading process. However, examples of the other components include carbon black, oil, stearic acid, anti-aging agent, zinc oxide, and the like.

A kneading method for the base kneading process is not particularly limited. For example, a kneading machine such as a Banbury mixer or a kneader can be used. Further, a kneading time (kneading time of the entire base kneading process) is preferably 3-20 minutes, and a rubber temperature (temperature of the kneaded material) during kneading is preferably 130-160° C.

In the base kneading process, with respect to the rubber temperature (first base kneading temperature) when the rubber component, the silane coupling agent and the silica are kneaded, the rubber temperature (second base kneading temperature) when the vulcanization accelerator is added and the resulting mixture is kneaded is preferably raised (preferably by 3° C. or more). As a result, the polycondensation reaction between the silica and the silane coupling agent can be further promoted.

### Finishing Kneading Process

In the finishing kneading process, the vulcanization agent is added to the kneaded material obtained by the base kneading process and the resulting mixture is kneaded.

The vulcanization agent that is added in the finishing kneading process is not particularly limited as long as the vulcanization agent is a chemical capable of cross-linking the rubber component. For example, sulfur and the like can be used. Further, a hybrid cross-linking agent (organic cross-linking agent) can also be used as a vulcanization agent in an embodiment of the present invention. These vulcanization agents may each be independently used, or two or more of these vulcanization agents may be used in combination. Among these vulcanization agents, sulfur is preferable.

In the finishing kneading process, it is also possible that, in addition to the vulcanization agent, other components are added and the resulting mixture is kneaded. Examples of the other components include a vulcanization accelerator, stearic acid, and the like.

As a vulcanization accelerator that is combined in the finishing kneading process, a vulcanization accelerator same as the vulcanization accelerator that is combined in the base kneading process can be used, but sulfenamides are preferable. Due to the sulfenamides, cross-linking is uniformized, and low fuel consumption performance, wear resistance and breaking strength are further improved.

Examples of the sulfenamides include N-cyclohexyl-2-benzothiazolylsulfenamide, N,N-dicyclohexyl-2-benzothiazolylsulfenamide, N-tert-butyl-2-benzothiazolylsulfenamide, N-oxydiethylene-2-benzothiazolylsulfenamide, N-methyl-2-benzothiazolylsulfenamide, N-ethyl-2-benzothiazolylsulfenamide, N-propyl-2-benzothiazolylsulfenamide, N-butyl-2-benzothiazolylsulfenamide, N-pentyl-2-benzothiazolylsulfenamide, N-hexyl-2-benzothiazolylsulfenamide, N-pentyl-2-benzothiazolylsulfenamide, N-octyl-2-benzothiazolylsulfenamide, N-2-ethylhexyl-2-benzothiazolylsulfenamide, N-decyl-2-benzothiazolylsulfenamide, N-dodecyl-2-benzothiazolylsulfenamide, N-stearyl-2-benzothiazolylsulfenamide, N,N-dimethyl-2-benzothiazolylsulfenamide, N,N-diethyl-2-benzothiazolylsulfenamide, N,N-dipropyl-2-benzothiazolylsulfenamide, N,N-dibutyl-2-benzothiazolylsulfenamide, N,N-dipentyl-2-benzothiazolylsulfenamide, N,N-dihexyl-2-benzothiazolylsulfenamide, N,N-dipentyl-2-benzothiazolylsulfenamide, N,N-dioctyl-2-benzothiazolylsulfenamide, N,N-di-2-ethylhexyl benzothiazolylsulfenamide, N-decyl-2-benzothiazolylsulfenamide, N,N-didodecyl-2-benzothiazolylsulfenamide, N,N-distearyl-2-benzothiazolylsulfenamide, and the like. These sulfenamides may each be independently used, or two or more of these sulfenamides may be used in combination. Among these sulfenamides, N-cyclohexyl-2-benzothiazolylsulfenamide and N-tert-butyl-2-benzothiazolylsulfenamide are preferable, and N-tert-butyl-2-benzothiazolylsulfenamide is more preferable.

A kneading method for the finishing kneading process is not particularly limited. For example, a kneading machine such as an open roll can be used. Further, a kneading time is preferably 1-15 minutes, and a rubber temperature during kneading is preferably 80-120° C.

In an embodiment of the present invention, a gel fraction of a kneaded material (unvulcanized rubber composition) obtained by the finishing kneading process is 30% or less. The gel fraction indicates an amount of bonding between the rubber component and a filler such as silica. When the gel fraction of the unvulcanized rubber composition becomes high, a portion of the rubber component and filler blocks react with each other and the dispersion of the silica is inhibited, and there is a risk that it may be difficult to ensure a sufficient breaking strength. In an embodiment of the present invention, by adjusting the gel fraction of the unvulcanized rubber composition to the above-described range, the silica can be satisfactorily dispersed. A lower limit of the gel fraction is not particularly limited, but is preferably 5% or more.

In an embodiment of the present invention, the gel fraction is a value measured using a method of examples to be described later, and can be adjusted according to a rubber temperature and an amount of the silane coupling agent during kneading.

### Vulcanization Process

In the vulcanization process, the kneaded material (unvulcanized rubber composition) obtained by the finishing kneading process is vulcanized. More specifically, the unvulcanized rubber composition is extruded according to a shape of a tire member such as a tread and is molded on a tire molding machine using an ordinary method, and is bonded together with other tire members to form an unvulcanized tire, which is then heated and pressed in a vulcanizer. Thereby, a tire can be manufactured. Vulcanization temperature is preferably from 150 to 200° C., and vulcanization time is preferably from 5 to 15 minutes.

For a reason that low fuel consumption performance, wear resistance and breaking strength can be obtained in a well-balanced manner, in a rubber composition obtained using a manufacturing method according to an embodiment of the present invention, a content of the high cis BR in 100 mass % of the rubber component preferably exceeds 20 mass % and is 80 mass % or less, and is more preferably 25 mass % or more and 70 mass % or less.

For a reason that low fuel consumption performance, wear resistance and breaking strength can be obtained in a well-balanced manner, in a rubber composition obtained using a manufacturing method according to an embodiment of the present invention, a content of SBR in 100 mass % of the rubber component is preferably 20 mass % or more and less than 80 mass %, and more preferably 30 mass % or more and 75 mass % or less.

In a rubber composition obtained using a manufacturing method according to an embodiment of the present invention, it is sufficient when a content of the silica exceeds 50 parts by mass with respect to 100 parts by mass of the rubber component. However, for a reason that low fuel consumption performance, wear resistance and breaking strength can be obtained in a well-balanced manner, the content of the silica is preferably 60 parts by mass or more and 300 parts by mass or less, and more preferably 70 parts by mass or more and 200 parts by mass or less.

For a reason that low fuel consumption performance, wear resistance and breaking strength can be obtained in a well-balanced manner, in a rubber composition obtained using a manufacturing method according to an embodiment of the present invention, a content of the silane coupling agent with respect to 100 parts by mass of the silica is preferably 1 parts by mass or more and 10 parts by mass or less, and more preferably 3 parts by mass or and 6 parts by mass or less.

For a reason that low fuel consumption performance, wear resistance and breaking strength can be obtained in a well-balanced manner, in a rubber composition obtained using a manufacturing method according to an embodiment of the present invention, a content of the vulcanization accelerator with respect to 100 parts by mass of the rubber component is preferably 0.5 parts by mass or more and 10 parts by mass or less, and more preferably 1.3 parts by mass or and 6 parts by mass or less.

For a reason that low fuel consumption performance, wear resistance and breaking strength can be obtained in a well-balanced manner, in a rubber composition obtained using a manufacturing method according to an embodiment of the present invention, a content of the vulcanization agent with respect to 100 parts by mass of the rubber component is preferably 0.1 parts by mass or more and 8 parts by mass or less, and more preferably 0.5 parts by mass or and 5 parts by mass or less.

### EXAMPLES

Based on examples, the present invention is described in detail. However, the present invention is not limited to only these examples.

In the following, various chemicals used in the example and comparative examples are collectively described.

SBR: Manufacturing Example 1

BR: Manufacturing Example 2

Silica 1: Ultrasil 9000GR (BET: 240 m²/g, CTAB: 200 m²/g, pH: 6.9) manufactured by Evonik Degussa Corporation

Silica 2: Ultrasil VN3 (BET: 175 m²/g, pH: 6.5) manufactured by Evonik Degussa Corporation

Silane coupling agent: Si75 (bis-(3-triethoxysilylpropyl) disulfide) manufactured by Evonik Degussa Corporation

Carbon black: Diablack I (ISAF class) (N₂SA: 114 m²/g) manufactured by Mitsubishi Chemical Corporation

Oil: High oleic acid sunflower oil (Oleic acid ratio: 82%; polyunsaturated fatty acid ratio: 9%; saturated fatty acid ratio: 9%) manufactured by Olisoy Corporation

Stearic acid: Bead stearic acid camellia manufactured by NOF Corporation

Anti-aging agent: Nocrac 6C (N-(1,3-dimethylbutyl)-N-phenyl-p-phenylenediamine) manufactured by Ouchi Shinko Chemical Industry Corporation

Zinc oxide: Two kinds of zinc oxide manufactured by Mitsui Mining & Smelting Co., Ltd.

Sulfur: Powdered sulfur manufactured by Tsurumi Chemical Industry Co., Ltd.

Vulcanization accelerator 1: Nocceler D (N,N′-diphenylguanidine) manufactured by Ouchi Shinko Chemical Industry Co., Ltd.

Vulcanization accelerator 2: Nocceler NS (N-tert-butyl-2-benzothiazolyl sulfenamide) manufactured by Ouchi Shinko Chemical Industry Co., Ltd.

### Manufacturing Example 1: SBR (Modified SBR)

36 g of 3-aminopropylmethyldiethoxysilane (manufactured by Gelest Corporation) is added as an aminosilane group to 400 mL of a dichloromethane solvent in a glass flask equipped with a stirrer under a nitrogen atmosphere. Thereafter, 48 mL of trimethylsilane chloride (manufactured by Aldrich Corporation) and 53 mL of triethylamine are further added as protected groups to the solution, and the resulting mixture is stirred for 17 hours at room temperature. Thereafter, by applying the reaction solution to an evaporator, the solvent is removed and a reaction mixture is obtained. Then, by subjecting the obtained reaction mixture to reduced-pressure distillation under a pressure of 665 Pa, as a fraction at 130-135° C., 40 g of N,N-bis(trimethylsilyl) aminopropylmethyldiethoxysilane, which is a modifying agent, is obtained.

Next, in an autoclave reactor having an internal capacity of 5 L (liter) replaced with nitrogen, 2,750 g of cyclohexane, 16.8 mmol of tetrahydrofuran, 125 g of styrene and 375 g of 1,3-butadiene are combined, and, after adjusting a temperature of reactor contents to 10° C., 1.2 mmol of n-butyllithium is added and polymerization is started.

At time when a polymerization conversion rate reaches 99%, 10 g of butadiene is added, and polymerization is further caused to proceed for 5 minutes. Next, 1.1 mmol of N,N-bis(trimethylsilyl) aminopropylmethyldiethoxysilane obtained above is added and a modification reaction is caused to proceed for 15 minutes. Thereafter, 0.6 mmol of tetrakis (2-ethyl-1,3-hexanediolato) titanium is added and the resulting mixture is further stirred for 15 minutes. 2,6-di-tert-butyl-p-cresol is added to a polymer solution after the reaction. Next, steam stripping is performed, and a rubber is dried using a hot roll adjusted to 110° C., and SBR is obtained. The obtained SBR has a glass transition temperature (Tg) of −38° C., a bonded styrene content of 24.5 mass %, and a conjugated diene portion vinyl content of 56 mol %.

### Manufacturing Example 2: BR (Modified High Cis BR)

2.4 kg of cyclohexane and 300 g of 1,3-butadiene are combined to a 5 L autoclave under a nitrogen atmosphere. To these, a catalyst is combined, which is prepared in advance by causing a cyclohexane solution of neodymium versatate (0.09 mmol), a toluene solution of methylalumoxane (1.0 mmol), a toluene solution of diisobutylaluminum hydride (3.5 mmol) and diethylaluminum chloride (0.18 mmol), and 1,3-butadiene (4.5 mmol) to react and age at 50° C. for 30 minutes, and a polymerization reaction is caused to proceed for 45 minutes.

Next, while a reaction temperature is kept at 60° C., a toluene solution of 3-glycidoxypropyltrimethoxysilane (4.5 mmol) is added and a reaction is caused to proceed for 30 minutes, and active terminal groups of a polymer are modified. Thereafter, a methanol solution containing 1.5 g of 2,4-di-tert-butyl-p-cresol is added.

Next, the above-obtained modified polymer solution is added to 20 L of an aqueous solution adjusted to pH 10 using sodium hydroxide. The resulting solution is subjected to desolvation at 110° C. for two hours and thereafter is dried using a hot roll at 110° C., and BR is obtained. The obtained BR has a cis content of 97 mass %, a vinyl content of 1.1 mass %, and an Mw of 350,000.

### Manufacturing Example 3: Example 1-2, Comparative Example 1

Using a Banbury mixer, chemicals described in Combine 1 of Process 1 in Table 1 are combined and the resulting mixture is kneaded for 3 minutes while adjusting the rubber temperature (temperature of the kneaded material) to about 145° C. Thereafter, the kneaded material is held in the Banbury mixer for 1 minute while the rubber temperature is adjusted to about 150° C.

Next, chemicals described in Combine 2 of Process 1 are combined to the Banbury mixer and the resulting mixture is kneaded for 3 minutes while the rubber temperature is adjusted to about 150° C. and thereafter, the kneaded material is discharged. Thereafter, the discharged kneaded material and chemicals described in Process 3 are combined into an open roll and are kneaded for 3 minutes while the rubber temperature is adjusted to about 110° C., and an unvulcanized rubber composition is obtained.

The obtained unvulcanized rubber composition is molded into a shape of a tread and is bonded together with other tire members on a tire molding machine to obtain an unvulcanized tire. The unvulcanized tire is vulcanized at 170° C. for 10 minutes and a test tire (size: 195/65R15; a tire for a passenger car) is manufactured.

### Manufacturing Example 4: Example 3

Using a Banbury mixer, chemicals described in Process 1 in Table 2 are kneaded for 3 minutes while the rubber temperature is adjusted to about 145° C. and thereafter the kneaded material is temporarily discharged. Next, the discharged kneaded material, together with chemicals described in Process 2, is re-combined to the Banbury mixer, and the mixture is kneaded for 3 minutes while the rubber temperature is adjusted to about 150° C. With other conditions the same as in Manufacturing Example 3, a test tire is manufactured.

### Manufacturing Example 5: Comparative Example 2

Using a Banbury mixer, chemicals described in Process 1 in Table 3 are kneaded for 6 minutes while the rubber temperature is adjusted to about 150° C. and thereafter the kneaded material is discharged. Thereafter, the discharged kneaded material and chemicals described in Process 3 are combined into an open roll and are kneaded for 3 minutes while the rubber temperature is adjusted to about 110° C. With other conditions the same as in Manufacturing Example 3, a test tire is manufactured.

The following evaluations are performed with respect to the obtained test tires and the like. The results are shown in Table 1-3.

### Gel Fraction

About 0.5 g of the kneaded material (unvulcanized rubber composition) after the finishing kneading process is finely cut and a mass thereof is accurately measured (Rg). A mass of a separately prepared 100 mesh stainless steel basket is precisely weighed (Kg), and a weighed sample is entirely transferred to the basket and a mass of the basket and the sample is measured (Rg+Kg). The basket containing the sample is immersed in a capped bottle containing 100 mL of toluene at 23° C. for 24 hours. Then, the basket is pulled up and is dried at 23° C. for 24 hours, and thereafter, is further subjected to reduced-pressure drying for 24 hours so as to have a constant weight at 70° C. A toluene insoluble matter and the basket are accurately weighed together (Gg+Kg), and a gel fraction is obtained using the following formula. A higher gel fraction indicates a more progressed reaction between filler such as silica and the rubber component.

Gel fraction (mass %)=100×[G−(R×((parts by mass of filler)/(total parts by mass of rubber composition)]/[(R×((parts by mass of rubber)/(total parts by mass of rubber composition)]

Parts by mass of filler: Total parts by mass of silica and carbon black of each combination in Table 1-3

Total parts by mass of rubber composition: Total parts by mass of all components of each formulation in Table 1-3

Parts by mass of rubber: Total parts by mass of rubber components of each combination in Table 1-3

### Non-Reaction Rate of Silane Coupling Agent

With respect to a kneaded material after the base kneading process, a non-reaction rate is obtained from a peak area of an unreacted portion of the silane coupling agent extracted using a liquid chromatography. Specifically, from each kneaded material, an unreacted portion of the silane coupling agent is extracted using acetone and a peak area (peak area 1) of the unreacted portion of the silane coupling agent is measured using a liquid phase chromatography method. Then, with respect to a reference solution containing the same amount of silane coupling agent as the silane coupling agent used in each kneaded material, the same procedure is performed and a peak area (peak area 2) is measured. From a ratio of the obtained peak area 1 to the obtained peak area 2, the non-reaction rate (%) of the silane coupling agent of the kneaded material after the base kneading process is calculated.

### Low Fuel Consumption Performance

Using a rolling resistance testing machine, rolling resistance of each test tire is measured when the test tire is mounted to a rim of 15×6JJ, is filled with air at an internal pressure of 230 kPa, is loaded with a load of 3.43 kN, and is caused to travel at a speed of 80 km/h. The result is expressed as an index number with a result of Comparative Example 1 as 100. A larger index number indicates a smaller rolling resistance and a better low fuel consumption performance.

### Wear Resistance

Each test tire is mounted on a domestic FF car. A groove depth of a tire tread part of the tire after a mileage of 8000 km is measured. A mileage when the groove depth of the tire decreased by 1 mm is calculated. The result is expressed as an index number with a result of Comparative Example 1 as 100. A larger index number indicates a larger mileage when the groove depth of the tire decreased by 1 mm, and a better wear resistance.

### Breaking Strength

Using a No. 3 dumbbell formed of a vulcanized rubber composition cut out from a tread of each test tire, a tensile test is performed according to JIS K6251, and strength at break (TB) and an elongation at break (EB) (%) are measured. A value of TB×EB/2 is defined as breaking strength and is expressed as an index number with a breaking strength of Comparative Example 1 as 100. A larger index number indicates a better breaking strength.

TABLE 1

| | | | | | | Comparative |
|---|---|---|---|---|---|---|
| | | | | Example | | Example |
| | | | | 1 | 2 | 1 |
| Composition | Base | Process 1 | SBR | 70 | 70 | 70 |
| (parts by mass) | kneading | Combine 1 | BR | 30 | 30 | 30 |
| | process | | Silica 1 | 75 | — | 75 |
| | | | Silica 2 | — | 75 | — |
| | | | Silane coupling agent | 3.5 | 3.5 | 6 |
| | | | Carbon black | 5 | 5 | 5 |
| | | | Oil | 5 | 5 | 5 |
| | | | Stearic acid | 0.5 | 0.5 | 0.5 |
| | | Process 1 | Vulcanization accelerator 1 | 1 | 1 | 1 |
| | | Combine 2 | Anti-aging agent | 2 | 2 | 2 |
| | | | Zinc oxide | 2 | 2 | 2 |
| | Finishing | Process 3 | Sulfur | 1.5 | 1.5 | 1.5 |
| | kneading | | Stearic acid | 1 | 1 | 1 |
| | process | | Vulcanization accelerator 1 | 0.5 | 0.5 | 0.5 |
| | | | Vulcanization accelerator 2 | 1.5 | 1.5 | 1.5 |

| | | | | |
|---|---|---|---|---|
| Measured values | Gel fraction (%) | 24 | 21 | 46 |
| | Silane coupling agent non-reaction | 4.2 | 3.5 | 23 |
| | rate (%) | | | |
| Performances | Low fuel consumption performance | 111 | 125 | 100 |
| | index number | | | |
| | Wear resistance index number | 125 | 113 | 100 |
| | Breaking strength index number | 122 | 114 | 100 |

TABLE 2

| | | | | Example |
|---|---|---|---|---|
| | | | | 3 |
| Composition | Base | Process 1 | SBR | 70 |
| (parts by mass) | kneading | | BR | 30 |
| | process | | Silica 1 | 75 |
| | | | Silica 2 | — |
| | | | Silane coupling agent | 3.5 |
| | | | Carbon black | 5 |
| | | | Oil | 5 |
| | | | Stearic acid | 0.5 |
| | | Process 2 | Vulcanization accelerator 1 | 1 |
| | | | Anti-aging agent | 2 |
| | | | Zinc oxide | 2 |
| | Finishing | Process 3 | Sulfur | 1.5 |
| | kneading | | Stearic acid | 1 |
| | process | | Vulcanization accelerator 1 | 0.5 |
| | | | Vulcanization accelerator 2 | 1.5 |

| | | |
|---|---|---|
| Measured values | Gel fraction (%) | 17 |
| | Silane coupling agent non-reaction rate (%) | 2.8 |
| Performances | Low fuel consumption performance index number | 117 |
| | Wear resistance index number | 130 |
| | Breaking strength index number | 128 |

TABLE 3

| | | | | Comparative |
|---|---|---|---|---|
| | | | | Example |
| | | | | 2 |
| Composition | Base | Process 1 | SBR | 70 |
| (parts by mass) | kneading | | BR | 30 |
| | process | | Silica 1 | 75 |
| | | | Silica 2 | — |
| | | | Silane coupling agent | 3.5 |
| | | | Carbon black | 5 |
| | | | Oil | 5 |
| | | | Stearic acid | 0.5 |
| | | | Vulcanization accelerator 1 | — |
| | | | Anti-aging agent | 2 |
| | | | Zinc oxide | 2 |
| | Finishing | Process 3 | Sulfur | 1.5 |
| | kneading | | Stearic acid | 1 |
| | process | | Vulcanization accelerator 1 | 1.5 |
| | | | Vulcanization accelerator 2 | 1.5 |

| | | |
|---|---|---|
| Measured values | Gel fraction (%) | 32 |
| | Silane coupling agent non-reaction rate (%) | 22 |
| Performances | Low fuel consumption performance index number | 94 |
| | Wear resistance index number | 86 |
| | Breaking strength index number | 92 |

From Table 1-3, it is clear that low fuel consumption performance, wear resistance and breaking strength are improved in a well-balanced manner for the tires of examples obtained using the manufacturing method that includes the base kneading process in which the rubber component, the silane coupling agent and the silica are kneaded and thereafter, the vulcanization accelerator is added and the resulting mixture is kneaded, and the finishing kneading process in which the vulcanization agent (sulfur) is added to the kneaded material obtained by the base kneading process and the resulting mixture is kneaded, and in which a gel fraction of the kneaded material obtained by the finishing kneading process is 30% or less.

In a tire rubber composition, in order to improve low fuel consumption performance, wear resistance and breaking strength in a well-balanced manner, a technology in which silica and a silane coupling agent are blended may be used.

A silane coupling agent reacts with both silica and a polymer. For a purpose of promoting dispersion of silica and activating a silane coupling agent, in the past, improvements in kneading methods and in blending chemicals have been studied (for example, see Japanese Translation of PCT International Application Publication No. 2003-523472). However, in recent years, further improvement is demanded.

A tire rubber composition manufacturing method according to an embodiment of the present invention allows low fuel consumption performance, wear resistance and breaking strength to be improved in a well-balanced manner.

A tire rubber composition according to an embodiment of the present invention includes a rubber component, a silane coupling agent, silica, a vulcanization accelerator and a vulcanization agent. A content of the silica exceeds 50 parts by mass with respect to 100 parts by mass of the rubber component. The tire rubber composition manufacturing method includes: a base kneading process in which the rubber component, the silane coupling agent and the silica are kneaded and thereafter, the vulcanization accelerator is added and the resulting mixture is kneaded; and a finishing kneading process in which the vulcanization agent is added to the kneaded material obtained by the base kneading process and the resulting mixture is kneaded. A gel fraction of the kneaded material obtained by the finishing kneading process is 30% or less.

It is preferable that the rubber component contain a high cis butadiene rubber that has a cis content of 70 mass % or more and a weight-average molecular weight of 300,000 or more, and a content of the high cis butadiene rubber exceed 20 mass % in 100 mass % of the rubber component.

It is preferable that the high cis butadiene rubber be a modified high cis butadiene rubber having a functional group that reacts with silica.

It is preferable that, in the kneaded material obtained by the base kneading process, a non-reaction rate of the silane coupling agent be less than 20%.

An embodiment of the present invention further relates to that includes a rubber component, a silane coupling agent, silica, a vulcanization accelerator, and a vulcanization agent. A content of the silica exceeds 50 parts by mass with respect to 100 parts by mass of the rubber component. The tire rubber composition is obtained using a manufacturing method that includes: a base kneading process in which the rubber component, the silane coupling agent and the silica are kneaded and thereafter, the vulcanization accelerator is added and the resulting mixture is kneaded; and a finishing kneading process in which the vulcanization agent is added to the kneaded material obtained by the base kneading process and the resulting mixture is kneaded. A gel fraction of the kneaded material obtained by the finishing kneading process is 30% or less.

In a method for manufacturing a tire rubber composition according to an embodiment of the present invention, a tire rubber composition includes a rubber component, a silane coupling agent, silica, a vulcanization accelerator and a vulcanization agent. A content of the silica exceeds 50 parts by mass with respect to 100 parts by mass of the rubber component. The method for manufacturing a tire rubber composition includes a base kneading process in which the rubber component, the silane coupling agent and the silica are kneaded and thereafter, the vulcanization accelerator is added and the resulting mixture is kneaded; and a finishing kneading process in which the vulcanization agent is added to the kneaded material obtained by the base kneading process and the resulting mixture is kneaded. A gel fraction of the kneaded material obtained by the finishing kneading process is 30% or less. Therefore, a tire rubber composition that allows low fuel consumption performance, wear resistance and breaking strength to be improved in a well-balanced manner can be manufactured.

Obviously, numerous modifications and variations of the present invention are possible in light of the above teachings. It is therefore to be understood that within the scope of the appended claims, the invention may be practiced otherwise than as specifically described herein.

What is claimed is:

1. A method for manufacturing a tire rubber composition, comprising:
kneading a rubber component, a silane coupling agent and silica such that a content of the silica exceeds 50 parts by mass with respect to 100 parts by mass of the rubber component;
adding a vulcanization accelerator to a kneading mixture comprising the rubber component, the silane coupling agent and the silica;
kneading the vulcanization accelerator and the kneading mixture comprising the rubber component, the silane coupling agent and the silica;
adding a vulcanization agent to a resulting mixture comprising the rubber component, the silane coupling agent, the silica and the vulcanization accelerator; and
kneading the vulcanization agent and the resulting mixture comprising the rubber component, the silane coupling agent, the silica and the vulcanization accelerator such that a kneaded material obtained by the kneading of the vulcanization agent and the resulting mixture has a gel fraction of 30% or less.

2. The method of claim 1, wherein the rubber component includes a high cis butadiene rubber having a cis content of 70 mass % or more and a weight-average molecular weight of 300,000 or more such that a content of the high cis butadiene rubber exceeds 20 mass % in 100 mass % of the rubber component.

3. The method of claim 2, wherein the high cis butadiene rubber is a modified high cis butadiene rubber having a functional group that reacts with the silica.

4. The method of claim 1, wherein the kneading of the vulcanization accelerator and the kneading mixture comprises kneading the vulcanization accelerator and the kneading mixture such that the silane coupling agent has a non-reaction rate of less than 20%.

5. The method of claim 2, wherein the kneading of the vulcanization accelerator and the kneading mixture comprises kneading the vulcanization accelerator and the kneading mixture such that the silane coupling agent has a non-reaction rate of less than 20%.

6. The method of claim 3, wherein the kneading of the vulcanization accelerator and the kneading mixture comprises kneading the vulcanization accelerator and the kneading mixture such that the silane coupling agent has a non-reaction rate of less than 20%.

7. The method of claim 1, wherein the content of the silica is in a range of 60 to 300 parts by mass with respect to 100 parts by mass of the rubber component.

8. The method of claim 1, wherein the silane coupling agent has a content in a range of 1 parts by mass to 10 parts by mass with respect to 100 parts by mass of the silica.

9. The method of claim 1, wherein the vulcanization accelerator has a content in a range of 0.5 parts by mass to 10 parts by mass with respect to 100 parts by mass of the rubber component.

10. The method of claim 1, wherein the vulcanization agent has a content in a range of 0.1 parts by mass to 8 parts by mass with respect to 100 parts by mass of the rubber component.

11. The method of claim 1, wherein the rubber component includes a high cis butadiene rubber having a cis content of 70 mass % or more and a weight-average molecular weight of 300,000 or more such that a content of the high cis butadiene rubber in a range of 20 mass % to 80 mass % in 100 mass % of the rubber component.

12. The method of claim 1, wherein the kneading of the vulcanization agent and the resulting mixture comprises kneading of the vulcanization agent and the resulting mixture such that the kneaded material obtained by the kneading of the vulcanization agent and the resulting mixture has the gel fraction in a range of 5% to 30%.

13. The method of claim 1, wherein the content of the silica is in a range of 60 parts by mass to 300 parts by mass with respect to 100 parts by mass of the rubber component, the silane coupling agent has a content in a range of 1 parts by mass to 10 parts by mass with respect to 100 parts by mass of the silica, the vulcanization accelerator has a content in a range of 0.5 parts by mass to 10 parts by mass with respect to 100 parts by mass of the rubber component, the vulcanization agent has a content in a range of 0.1 parts by mass to 8 parts by mass with respect to 100 parts by mass of the rubber component, the rubber component includes a high cis butadiene rubber having a cis content of 70 mass % or more and a weight-average molecular weight of 300,000 or more such that a content of the high cis butadiene rubber in a range of 20 mass % to 80 mass % in 100 mass % of the rubber component, and the kneading of the vulcanization agent and the resulting mixture comprises kneading of the vulcanization agent and the resulting mixture such that the kneaded material obtained by the kneading of the vulcanization agent and the resulting mixture has the gel fraction in a range of 5% to 30%.

14. A tire rubber composition, comprising:
a kneaded material comprising a rubber component, a silane coupling agent, silica, a vulcanization accelerator, and a vulcanization agent such that the silica has a content exceeding 50 parts by mass with respect to 100 parts by mass of the rubber component and that the kneaded material has a gel fraction of 30% or less.

15. The tire rubber composition of claim 14, wherein the rubber component includes a high cis butadiene rubber having a cis content of 70 mass % or more and a weight-average molecular weight of 300,000 or more such that a content of the high cis butadiene rubber exceeds 20 mass % in 100 mass % of the rubber component.

16. The tire rubber composition of claim 15, wherein the high cis butadiene rubber is a modified high cis butadiene rubber having a functional group that reacts with the silica.

17. The tire rubber composition of claim 14 obtained by a method comprising kneading the rubber component, the silane coupling agent and the silica, adding the vulcanization accelerator to a kneading mixture comprising the rubber component, the silane coupling agent and the silica, kneading the vulcanization accelerator and the kneading mixture comprising the rubber component, the silane coupling agent and the silica, adding the vulcanization agent to a resulting mixture comprising the rubber component, the silane coupling agent, the silica and the vulcanization accelerator, and kneading the vulcanization agent and the resulting mixture comprising the rubber component, the silane coupling agent, the silica and the vulcanization accelerator such that the kneaded material obtained by the kneading of the vulcanization agent and the resulting mixture has the gel fraction of 30% or less.

18. The tire rubber composition of claim 17, wherein the rubber component includes a high cis butadiene rubber having a cis content of 70 mass % or more and a weight-average molecular weight of 300,000 or more such that a content of the high cis butadiene rubber exceeds 20 mass % in 100 mass % of the rubber component.

19. The tire rubber composition of claim 18, wherein the high cis butadiene rubber is a modified high cis butadiene rubber having a functional group that reacts with the silica.

20. The tire rubber composition of claim 17, wherein the kneading of the vulcanization accelerator and the kneading mixture comprises kneading the vulcanization accelerator and the kneading mixture such that the silane coupling agent has a non-reaction rate of less than 20%.
